(19) United States
(12) Patent Application Publication
(10) Pub. No.: US 2008/0208929 A1
(43) Pub. Date: Aug. 28, 2008

(54) System And Method For Backing Up Computer Data

(76) Inventor: Mark Phillipi, Fort Mill, SC (US)

Correspondence Address: KAPLAN GILMAN GIBSON & DERNIER L.L.P., 900 ROUTE 9 NORTH, WOODBRIDGE, NJ, 07095, US

(21) Appl. No.: 11/677,691

(22) Filed: Feb. 22, 2007

(51) Int. Cl. G06F 17/30

(52) U.S. Cl. 707/204; 707/E17.001

(57) ABSTRACT

A system and method are disclosed that may include providing a computer network; maintaining a backup database for the computer network; establishing a value of at least one backup parameter for at least one given data element based on at least one attribute of the at least one given data element; and saving the at least one given data element to the database in accordance with the established value.

### BACKGROUND OF THE INVENTION

The present invention relates in general to computer networks and more particularly to systems and methods for providing data backup for recovery from data loss.

Businesses of various kinds are increasingly dependent on information technology to operate effectively. Moreover, the total amount of stored company data continues to grow at about 50% per year. Thus, the vulnerability of data processing systems and the data stored thereon poses significant financial risk to such businesses. In spite of advances in computing technology, failures of data processing systems and associated data storage systems continue to occur.

Several metrics describe the effectiveness of the response to such failures: the time required to restore operation of the equipment, the time required to restore stored data associated with the business experiencing the failure, and the age of the restored data. The age of the restored data may also be expressed in terms of the number of changes to the data that may need to be re-entered to restore the condition the data was in at the moment of failure. As shown below, existing approaches do not fare well using the above-listed figures of merit.

Currently, company computer systems are backed up on magnetic tape, which may then be carried to a secure location for storage. This process may be repeated as frequently as is feasible. Daily backup and storage is relatively common. In the event of a system failure, the most recently saved tape is returned to the company site and used to restore the operating system(s) and various types of saved data to various onsite computers. Given the variation of operating systems, software installations having varying versions, and the different data to be restored to different computers, fully restoring all computers at a company site can take a day or more. This by itself imposes a significant economic loss on the affected company.

Moreover, the restored data may be as much as one day old, thereby causing the company to expend still further time, possibly as much as several days, restoring the data that was present on the company's computer system at the time of the failure. Thus, using the above-identified metrics, the existing tape storage approach may require several days to make the system operational and fully restored. One to two days of down time would present most businesses with major economic losses. There is therefore a need in the art for a system and method for enabling more rapid system recovery and data restoration.

### SUMMARY OF THE INVENTION

A first backup server is used to provide backup services for numerous files and applications on plural different client computers at a site. The first backup server is also connected optionally to a second, remotely located, vaulted backup server, and communications between the backup servers may be encrypted.

In accordance with one aspect of the invention, the granularity of the backup may vary among the client computers, or among the applications, and may be customized to each. Thus, data may be backed up once per day, once every specified number of transactions, in real time for each single transaction, once per hour, or at any other frequency. Additionally, intelligence about the data being backed up on each client, or with respect to each application, is used to customize the backup frequency so that data is backed up enough to ensure that the backup is relatively current, but not too often so that data from applications that does not change all that frequently is not unnecessarily backed up.

In another aspect of the invention, the encryption used to store the backed up data, or to transmit the backed up data from the first backup server to the second, may be customized per client, per application, etc. For example, data may be encrypted in bulk so that a user cannot read any part or gain any information from the encrypted data. Alternatively, each file may be encrypted so that a user can view the directories and files stored, but simply cannot read the data in the files.

The granularity of the backup, the encryption, or any other parameters may be customized for each computer, each application, each directory, or any other logical element.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram of a plurality of client stations in communication with a remote server and storage device over the Internet, in accordance with the present invention;

FIG. 1A is an exemplary embodiment of the present invention;

FIG. 2 is a block diagram showing a client station in accordance with FIG. 1 in greater detail, in accordance with the present invention;

FIG. 3 is a block diagram of an exemplary embodiment of a computer station of FIG. 2, in greater detail, in accordance with the present invention;

FIG. 4 is a block diagram of a data backup operation employing disk level storage granularity in accordance with the present invention;

FIG. 5 is a block diagram of a data backup operation employing block level storage data granularity level in accordance with the present invention;

FIG. 6 is a block diagram of a data backup operation employing file level data granularity level frequency in accordance with the present invention.

FIG. 7 is a block diagram of stored data having record-level encryption applied thereto, in accordance with the present invention;

FIG. 8 is a block diagram of stored data having file-level encryption applied thereto, in accordance with the present invention;

FIG. 9 is a block diagram of stored data having block-level encryption applied thereto, in accordance with the present invention;

FIG. 10 is a table showing exemplary data backup intervals for a selection of information categories in accordance with the present invention; and

FIG. 11 is a table showing exemplary granularity selections for respective backup parameters based on attributes of the data being backed up, in accordance with the present invention.

### DETAILED DESCRIPTION OF THE PREFERRED EMBODIMENTS

The present invention may be operable to provide flexible and efficient systems and methods for backing up computer data so as to enable more rapid and more complete recovery in the event of a catastrophic loss of data. The systems and methods disclosed herein may enable data to be transferred from a primary storage device to a backup storage device electronically, thereby avoiding the use of magnetic tape and the delays associated therewith. Such electronic communication may conducted between a backup storage device located at the same computing site as the primary storage device (using an intermediary computer) and/or between one or more backup storage devices at a client site and one or more backup storage devices located remotely from the one or more primary storage devices. Where the primary storage device and the backup storage device are located remotely from one another, they may communicate via the Internet or other suitable data network. The computers and/or servers may serve as intermediaries between one or more primary storage devices and one or more backup storage devices.

Data backup operations may include providing a full backup of a disk, data block, file, directory, or other body of data at a selected backup frequency. However, providing full data backups in each such backup operation may consume inordinate amounts of time and storage space, and may consequently force the backup operations to be conducted less frequently, thereby incurring the risk that more data may be lost in the event of a breakdown of a primary storage device. Accordingly, it would be desirable to be able to establish data backup frequency that is compatible with the data recovery requirements of each application, without employing excessive amounts of storage space on the backup storage device(s).

In accordance with one embodiment of the invention, a desirable data backup frequency may be achieved without employing an excessive amount of storage. The goals may be achieved by tailoring various parameters of the data backup process in accordance with one or more attributes of the information being backed up. The aspects of the data backup process that may adjusted in accordance with data attributes may include the data storage granularity, the encryption data granularity, and/or the data backup interval, which may be considered to be a form of “time granularity.” The data backup interval may alternatively be expressed as a data backup frequency. Moreover, two or more backup parameters of the foregoing may be adjusted for any given data element in accordance with the attributes thereof.

The following discussion is directed first to network and computer hardware configurations that may employ the methods described herein, and thereafter to descriptions of variations of the data backup aspects listed above. While the various data storage granularity adjustments are discussed separately, it will be appreciated that a selected record, file, transaction, data block, disk of data, or other data quantity may be backed up in accordance with any number of such backup specifications at once. For example, a selected type of data, such as “financial transactions” may be backed up on a file-by-file basis (data storage granularity), in accordance with a defined data backup frequency (e.g. full backup once per day, and incremental backups once per minute), and/or an encryption data granularity (e.g. leaving file names and dates visible, but encrypting the contents of each file).

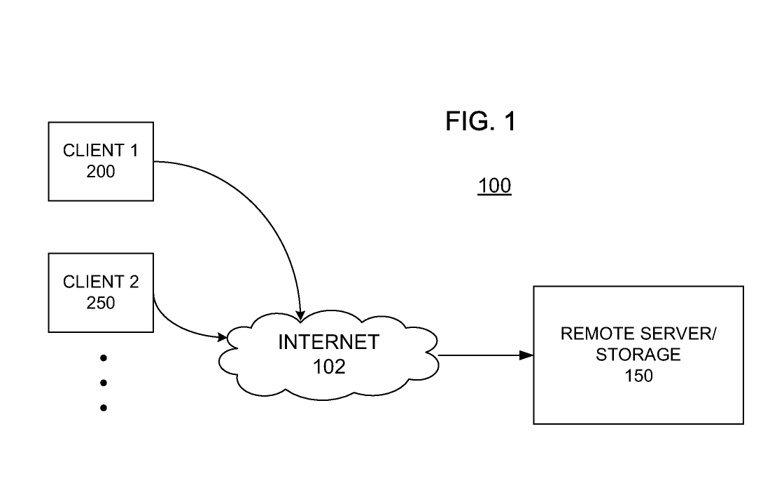

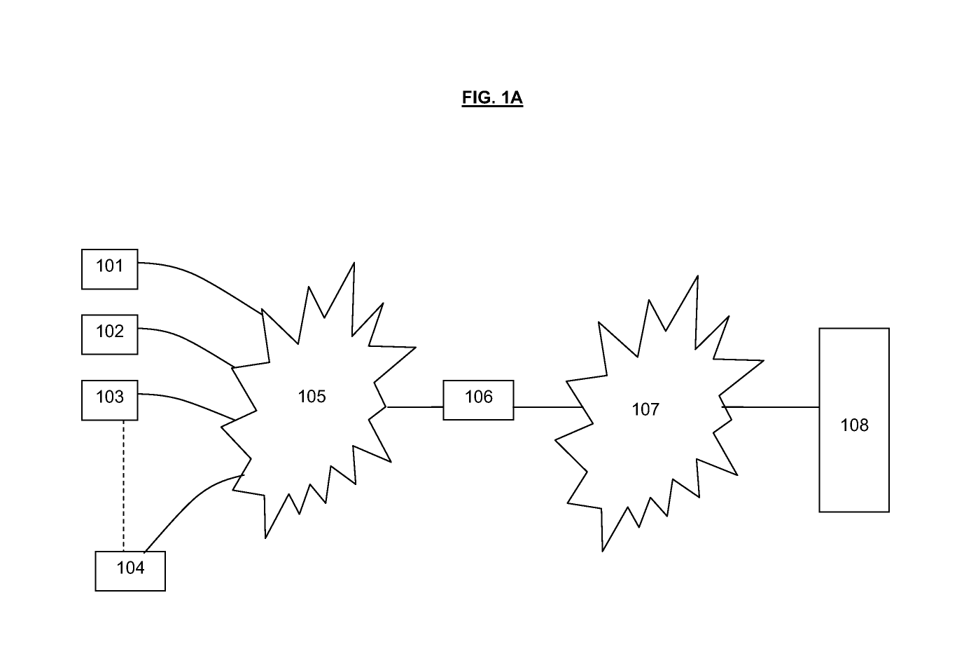

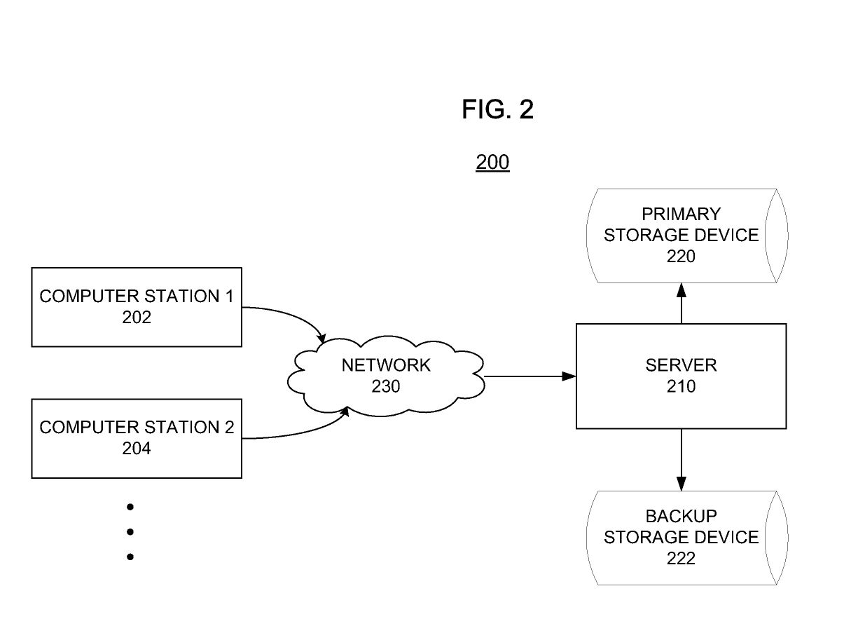

FIG. 1 is a block diagram 100 of a plurality of client stations 200, 250 in communication with a remote server and storage device 150 over the Internet 102, in accordance with of the present invention. A computer network 100 may include client 1 200 (or “client station”), client 2 250, and/or remote server/storage device 150 which may be connected to clients 1 and 2 (200 and 250) via the Internet 102. The contents of an exemplary client station 200 are discussed in greater detail in connection with FIG. 2. While two client stations 200 and 250 are shown in FIG. 1, data network 100 may include any number of client stations as indicated by the vertical ellipsis below the client 2 250 block. Moreover, any number of remote server and/or storage devices may be employed in accordance with the present invention.

The various data backup algorithms discussed herein may be employed to back up data between two computing stations within any one client station, between two client stations, and/or between a client station and remote server/storage 150. While client stations are shown connected to remote server/storage device 150, and to each other, over the Internet 102, it will be appreciated by those of ordinary skill in the art that any suitable data network could be employed.

FIG. 1A is a conceptual diagram of another exemplary system that implements some of the generic concepts described in more detail below. In the example of FIG. 1A, plural client computers 101-104 are resident in an office environment, and an internal local area network (LAN) 105 is utilized for internal communications with an on site backup server 106. The internal backup server may also be connected to a secondary backup server. In one example, such connection is over a wide area network (WAN) 107 to a vaulted, remote backup server 108. In one exemplary embodiment, the WAN 107 is the Internet, and the remote backup server 108 may service plural local backup servers 106 from various organizations.

In accordance with one aspect of the present invention, the frequency of backup may be different for each of computers 101-104, based upon the type of data each of stores. Thus, either an authorized user of client computers 101-104, or an administrative user of backup server 106 may program backup server 106 and the computers 101-104 to implement the desired backup frequency. Thus, the backup of the data on backup server 106 for computer 101 may be, for example, no older than one minute, but the backup of the data on clients 102 and 103 may be as old as 12 hours if those computers 102-103 are only backed up twice per day. Similarly, computer 104 may be backed up once per hour. Thus, the backup server 106, while it may contain backup data from all of the computers 101-104, actually contains backups that are of differing “granularity” from the different computers.

The foregoing feature is particularly useful in situations where data on the different computers has different levels of time criticality. For example, one computer may have the data related to ongoing financial transactions that occur plural times per minute. Another computer may have the employee records data. The later can be backed up infrequently, as it does not change much in a day. However, the former should be backed up more frequently.

The present invention provides for flexibility in that it permits each computer's backup frequency to be customized based upon factors such as how often the data typically changes, and/or how critical it is. Moreover, the backup frequency may be programmed into the backup server 106, configured at the client computers 101-104, or set by other means. One possibility is to encode a tag at the computers 101-104 that the backup sever 106 can read to ascertain the backup frequency. Another possibility is to provide intelligence into the system, for example, permitting the backup server 106 to monitor the frequency at which data on the computers 101-106 changes, and to set the backup frequency automatically based upon the rate of change of data on any of the computers 101-104. Additionally, the backup frequency may change based upon time of day, day of week, etc.
a. It is also noted that while the variances in backup frequency, and the techniques of configuring same, may vary from computer to computer 101-104 as heretofore described, the same techniques can be applied across directories within the computers 101-104, or across any other unit of data. For example, the frequency of backup may be set for each directory, or a hard drive can be divided into two different virtual drives, using known software techniques, and the backup frequency for each virtual drive set independently. This is referred to herein as varying the “granularity” of the backup, in the sense that it allows the item of data to which a particular backup frequency applies to be configured.
b. The granularity at which the backup frequency applies may itself be configurable through software. Thus, the system may be configured through a user interface at the computers 101-104 and/or backup server 106. Such configuration may include instructions, for example, as follows: Server 101 to be backed up hourly, Server 102 to be divided, with directories 1-4 backed up hourly, and directories 5-8 backed up daily, server 103 to be backed up twice per hour, except on Saturday and Sunday, when it is to be backed up only once per day. For server 104, the files on virtual disk 1 should be backed up daily, and the files on virtual disk 2 should be divided into two groups, with the first five files being backed up once per hour, and the remaining five being backed up each day.

As the example shows, virtually infinite combinations of frequency of backup and granularity of the set of data to which the backup frequency applies are possible. Tags or other data can be inserted to indicate the backup frequency and granularity to which that backup frequency applies. The system, as a general rule, addresses an age old problem in backup and restoration. That is, the system balances the competing interests of backing up as frequency as possibly to ensure that the backed up data is current, and not backing up so much data so often such as to overwork the system. The present invention permits the two tradeoffs to be customized to meet the needs of individual sets of data or computers to which the method will be applied.

The techniques described above can also be applied to the secondary backup between backup server 106 and a secondary backup server, such as, for example, remote server 108. In that case, the granularity and frequency of data transfer between servers 106 and 108 can be set. For example, certain data can be transferred for secondary backup to server 108 more frequently than other data. Additionally, the granularity can be set for the encryption as well, so that the whole stream is encrypted and unreadable, or that individual files are shown but the contents not readable, etc. Thus, the unit of data upon which the encryption between servers 108 and 106 operates can be configured from a server, to a directory, to a file, etc, just as the backup frequency can have its unit adjusted.

FIG. 2 is a block diagram showing a client station 200 in accordance with FIG. 1 in greater detail, in accordance with an exemplary embodiment of the present invention. Client station 1 200 may include computer station 1 202, computer station 2 204, and any number of additional computer stations as indicated by the vertical ellipsis below computer station 2 204. Client station 200 may further include one or more servers 210, which may each be coupled to one or more primary storage devices 220, and/or one or more backup storage devices 222. Server 210 may be coupled to computer stations 202 and 204 over network 230, which may be a conventional Local Area Network (LAN) or other suitable data network.

Additionally, a backup storage device 222 may be coupled to a remote secondary storage device (not shown) that can be vaulted in another state or other very remote location. This would account for the possibility of backup storage device 222 being itself lost via a natural disaster, etc.

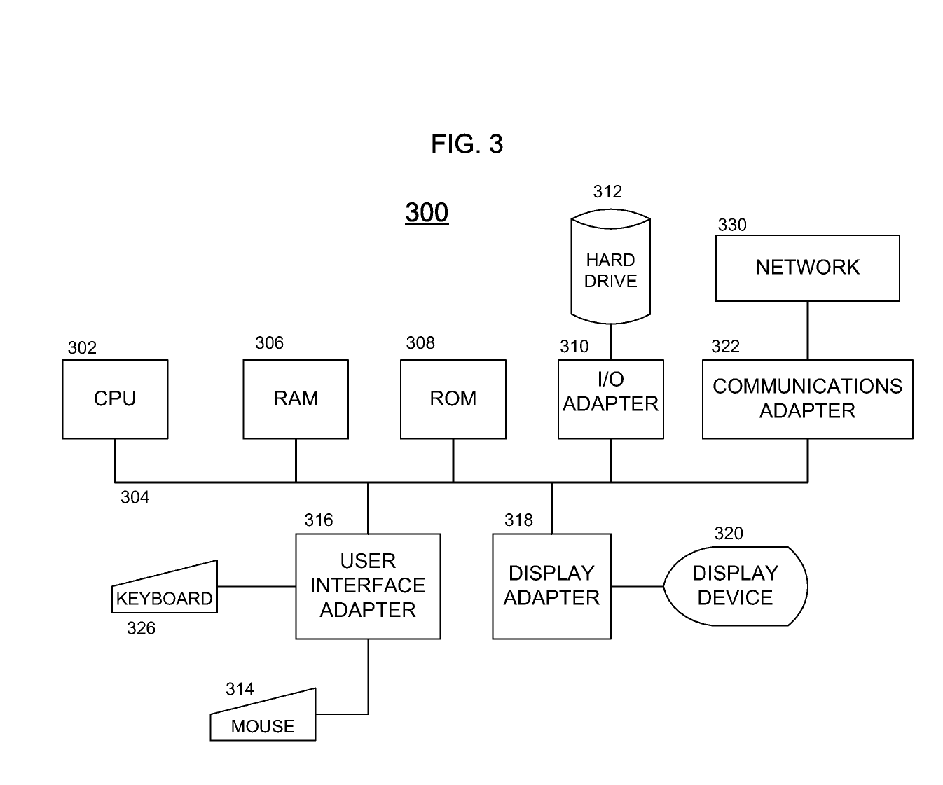

A representative computer station 300, which may generally correspond with computers stations 202 and 204, is described in greater detail in connection with FIG. 3. Server 210 may be a conventional server computer. Primary storage device 220 may include one or more hard disk drives, and/or other form of non-volatile data storage and/or a volatile data storage capability. Backup storage device 222 may include one or more hard disk drives and/or other form of non-volatile data storage and/or a volatile data storage capability. In one or more alternative embodiments of the present invention, backup storage device 222 may include specialized additional computing functionality to enable backup storage device 222 to convert from serving as a backup data storage device to operating as server instead of, or in addition to, serving as a backup device, in the event of a failure of primary storage device 220.

FIG. 3 is a block diagram of an exemplary embodiment of a computer station 300 of FIG. 2 in accordance with the present invention. Computer station 300 (or “computing station”) of FIG. 3 may generally correspond to computer stations 202 or 204 of FIG. 2.

A central processing unit (CPU) 302 may be coupled to bus 304. In addition, bus 304 may be coupled to random access memory (RAM) 306, read only memory (ROM) 308, input/output (I/O) adapter 310, communications adapter 322, user interface adapter 306, and/or display adapter 318.

A RAM 306 and/or ROM 308 may hold user data, system data, and/or programs. I/O adapter 310 may connect storage devices, such as hard drive 312, a CD-ROM (not shown), or other mass storage device to computing system 300. Communications adapter 322 may couple computing system 300 to a local, wide-area, or Internet network 330. A network 330 of FIG. 3 may correspond to network 230 of FIG. 2. User interface adapter 316 may couple user input devices, such as keyboard 326 and/or computer mouse or other computer pointing device 314, to computing system 300. Moreover, display adapter 318 may be driven by CPU 302 to control the display on display device 320. CPU 302 may be any general purpose CPU.

### Introduction to Data Backup Parameters

The following discussion is directed to an embodiment of the present invention in which one or more data backup parameters (or simply “backup parameters”) may be established in accordance with one or more attributes of a body of data or “data element” to be backed up. By way of overview, the backup granularity parameters (or “backup settings”) that may be modified may include a) data storage granularity; b) an encryption granularity level (or, “data encryption granularity level”); c) and/or a data backup interval. A data backup interval may be inversely related to the “data backup frequency”. However, other data backup parameters could be modified using one or more attributes of the data element being backed up, in accordance with of the present invention.

A data element may be whatever body of data is sought to be saved. A data element may possess one or more of various attributes, which attributes may include an information category, a security level, a priority level, and a recency of a last change (i.e. how recent the last change is) to the data element in a relevant storage device, such as the primary storage device. However, the invention is not limited to the above-listed data element attributes, and other attributes may be employed to set the values of various data backup parameters. A selection above the above terms is further described below.

A “transaction” may include an email, information describing a financial transaction (such as a stock purchase), or other logically complete unit of information suitable for storage to a data storage device. Any other logical unit of processing may constitute a transaction as well.

An information category may include but is not limited to: appointment data; email data; text files; financial transactions; and/or security information. Security information may include but is not limited to any highly secure information such as, but not limited to building access codes, passwords, diplomatic communication; and/or national security information.

Since the total number of combinations of data backup parameter values may be very high, three of the backup parameters contemplated by the present invention are discussed separately below. However, values of two or more of the three data backup parameter may be combined when backing up a selected data element or “body of data.”

For example, a given file may be backed up with the data storage granularity set to the record level (that is, by separately saving the records as units of storage, rather saving the file as a single unit), and wherein the data backup interval is established such that full backups occur once per day, and incremental backups once per hour. Moreover, to expand the example to include a third data backup parameter, the given file may be backed up using an encryption granularity at the record level, which may enable the file itself to be moved and saved, and selected records of the given file to be unencrypted, while other selected records of the given file would be encrypted. Many other combinations of backup granularity parameters are possible. Moreover, end users may establish a wide range of possible data attributes upon which each of the settings of the data backup parameters may be chosen.

Moreover, a given data element, such as a file, may be concurrently stored (backed up) using different values of one or more data backup parameters. For example, different values of a given data backup parameter may be established for different “data sizes”. For example, Block A may include file A3. File A3 may be stored at a “file level” using an incremental backup interval of one minute (that is, saving new changes to the file once per minute). In an independent operation, Block A may be stored to the backup storage device, at the block level, using an incremental backup employing a data backup interval of one hour. Thus, the invention may concurrently store data at different levels of data storage granularity and/or using different data backup intervals. Moreover, continuing with the example, different encryption granularity levels may be employed for the above-mentioned file-storing and block-storing operations.

Having introduced the data backup parameters and the criteria for establishing values of the respective data backup parameters, the discussion is now directed to a selection of figures illustrating more specific applications of the above concepts.

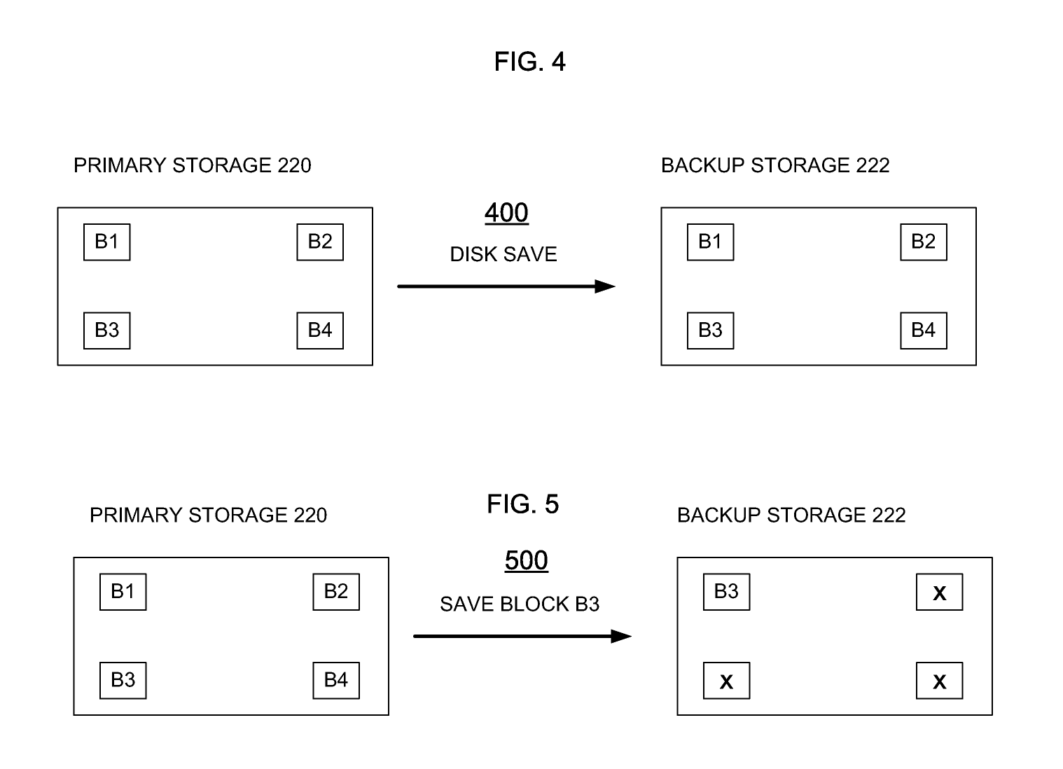

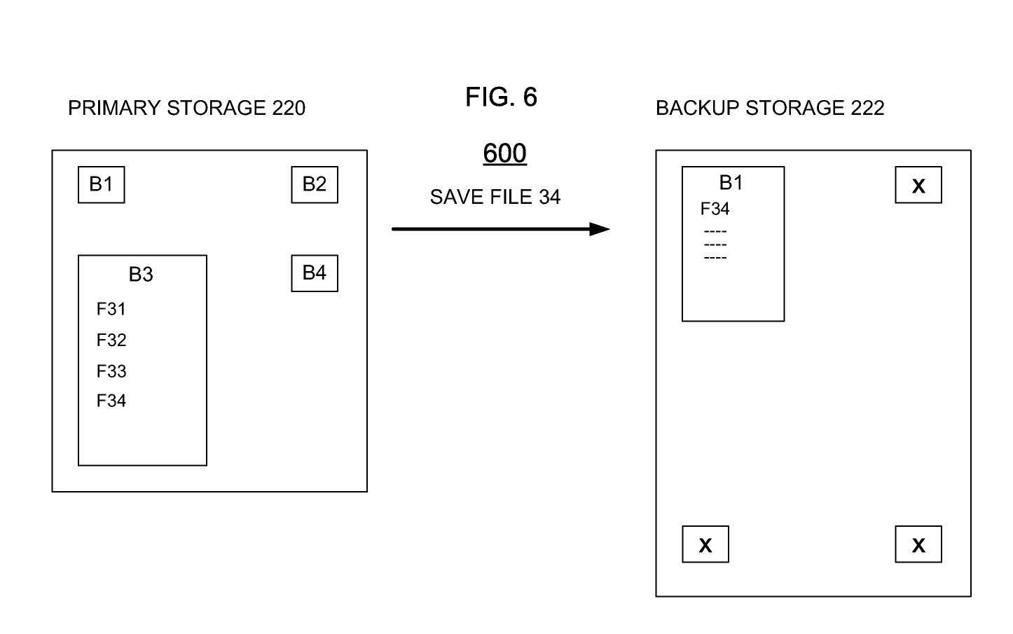

FIG. 4 is a block diagram of a data backup operation 400 employing a disk level storage granularity in accordance with the present invention. FIG. 5 is a block diagram of a data backup operation 500 employing a block level storage data granularity level in accordance with of the present invention. And, FIG. 6 is a block diagram of a data backup operation 600 employing a file level data granularity level frequency in accordance with of the present invention. For the sake of convenience, FIGS. 4-6 illustrate data backup storage operations from primary storage device 220 to backup storage device 222. However, in general, a computer or server 210 may serve as an intermediary between storage devices 220 and 222, where the backup data already resides on primary storage device 220. In one or more other embodiments, data transfers to backup storage device 222 may be conducted from the Random Access Memory (RAM) of server 210 without having been previously saved to primary storage device 220.

FIG. 4 depicts a data storage operation 400 from primary storage device 220 to backup storage device 222. In one more embodiments, a “disk save” may be conducted in which the bit-for-bit data storage and arrangement of the disk of primary storage device 220 is duplicated on a disk within backup storage device 222. The described save operation thus employs “disk level” data storage granularity in accordance with the present invention.

FIG. 5 depicts a data storage operation 500 from primary storage device 220 to backup storage device 222. A “block save” may be conducted in which block “B3” from primary storage device 220 may be saved to backup storage device 222. It will be recognized that the expression “B3” for the block saved in the exemplary storage operation is used for purposes of illustration. Block B3 may be uniquely identifiable within backup storage device 222, irrespective of the numbering of other blocks within the disk of backup storage device 222.

In accordance with the teachings of the invention, when employing a “block level” data storage operation, data block B3 need not stored at a location on a disk in within primary storage device 222 that corresponds to the storage location of data block B3 on the disk it originated from in primary storage device 220. Since data block B3 is preferably uniquely identifiable within backup storage device 222, in one more embodiments, data block B3 may be stored in any suitable location within data storage device 222. However, the arrangement of data within data block B3 is preferably the same when stored within backup storage device 222 as the arrangement of data is within data block B3, as stored in primary storage device 220.

FIG. 6 depicts a file-level data storage operation from primary storage device 220 to backup storage device 220 in which operation server 210 may serve as an intermediary device. Thus, in this example, the data storage granularity level may be set to the file level. In one more embodiments, file 34 may reside within data block B3 of primary storage device 220. File 34 may be backup up at the “file level” of data storage granularity. Thus, file 34 may be stored within backup storage device 220 without necessarily occupying the same location within backup storage device 222 as file 34 occupies within primary storage device 220. In the example of FIG. 6, file 34 is stored within data block B1 of backup storage device 220. (Block B1 may be located on a hard drive within backup storage device 220). File 34 is uniquely identifiable within backup storage device 222, and therefore need not be located in any particular portion of any particular block within backup storage device 222, in order to be retrieved in a data recovery operation.

Metadata for a file, such as file 34 of FIG. 6, may be stored in backup storage device 222, in addition to the file itself. Such metadata may aid in uniquely identifying the stored file for later recovery. Thus, metadata may include but is not limited to: the date and time at which a file was saved to backup storage device 222, the identification of a computer station or client station from which the saved file originated, a database from which the file originated, a database that the file is part of, a data table that the backed up file forms a part of, and/or additional information.
a. Where sufficiently fine data backup time intervals are employed, metadata may enable every “add”, “delete”, and/or “change” operation to be stored in the data backup device 222. Such data may enable a version of a specified record corresponding to a particular point in time to be recovered in a subsequent data recovery operation.

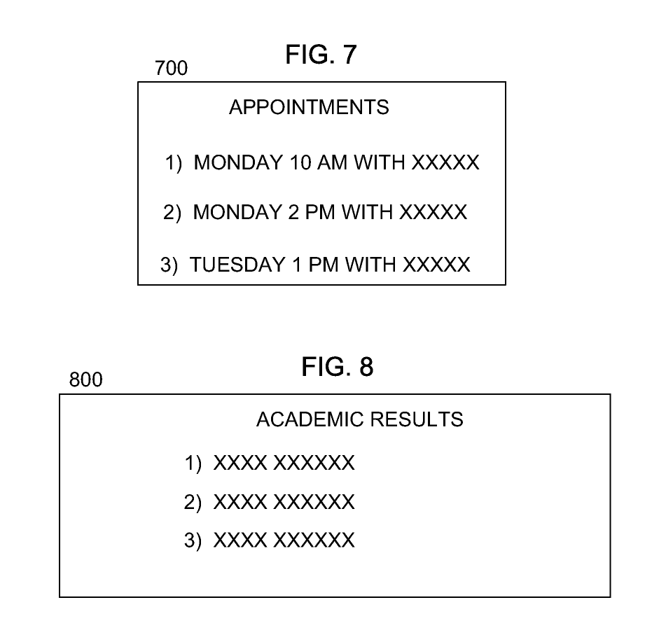

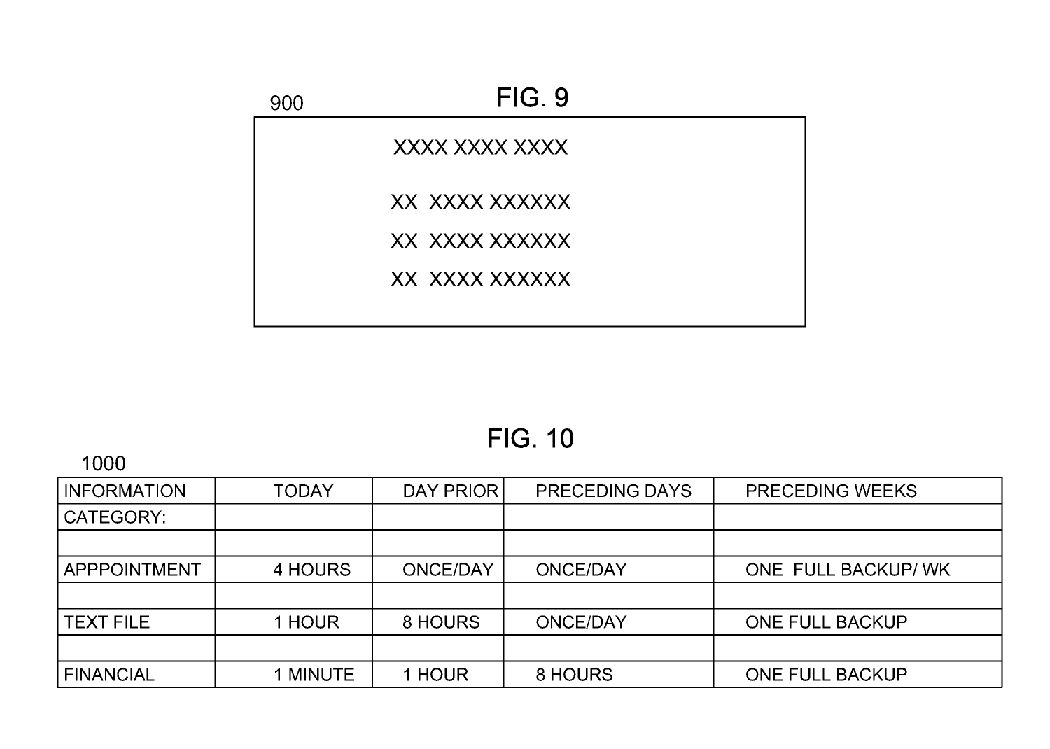

The encryption granularity level applied to data stored on backup storage device 222 may vary in accordance with one or more attributes. Accordingly, FIGS. 7-9 are directed to representations of backup data encrypted at different levels of granularity. FIG. 7 is a block diagram of stored data to which record-level data encryption may be applied, in accordance with of the present invention. FIG. 8 is a block diagram of stored data to which file-level data encryption may be applied, in accordance with of the present invention. And, FIG. 9 is a block diagram of stored data to which block-level data encryption may be applied, in accordance with of the present invention. In FIGS. 7-9, sequences of “X” characters denote encrypted information.

FIG. 7 depicts a simplified exemplary data block including a plurality of files and records in which record-level encryption is applied. In the example of FIG. 7, each numeral and the text to the right thereof represents a file that may include one or more records. Thus “1) MONDAY 10 AM WITH XXXXX” corresponds to one file. Two additional files starting with “2)” and “3)” are also shown. For the sake of this discussion, the numerals “1”, “2”, and “3” are considered to be file names.

When employing record-level encryption, the file may be opened, and one or more unencrypted records in each such file may also be visible without employing a public key. In the example of FIG. 7, only one record within file “1” is encrypted and inaccessible to an entity without a key, such as, for instance, a third party data vault administrator which could be located at remote server/storage 150 (FIG. 1).

The record-level encryption of FIG. 7 may be employed where the existence of appointments and their respective dates and times is not confidential, but where the identities of one or more persons present for each appointment are considered confidential. For example, a doctor's office could maintain records using record-level encryption. It would generally not be a secret that files exist that list appointments along with the dates and times thereof. Thus, the unencrypted information shown in FIG. 7 would not compromise the privacy of any patient. However, individual patients may well wish to keep their information private. And, accordingly, the record-level encryption of FIG. 7 enables such information to be encrypted and therefore unavailable to any entity not having a key able to decrypt the encrypted data. Thus, such information could be stored, moved, and restored to a primary storage device from a backup storage device without needing the public key to the encrypted data.

FIG. 8 depicts an exemplary data block 800 that employs file level encryption. In, as with record-level encryption, when employing file-level encryption, individual files may be identified, moved, saved, and restored without a need for the public key. However, file-level encryption may provide greater security than record-level encryption, since with file-level encryption, the file as a whole cannot be opened without a public key corresponding to the encryption algorithm.

In another example, a file level encryption could be applied to academic test result data that, for instance, lists names of people in various result categories, and their respective grades in a course or exam. In a case where the names and the test data are both confidential, all records in the file may suitably be kept confidential by employing file-level encryption.

FIG. 9 depicts an exemplary data block 900 in which block-level encryption had been employed. In this case, although the existence of the block may be known to unauthorized parties, no data in block 900 may be accessed without a key. Block-level encryption could be applied to relatively sensitive data, such as national security information where it is intended to restrict knowledge of ames and existence of various files within block 900 to authorized parties.

Backup data may include data from two backup operation types that may combine to provide a complete and current copy in backup storage device 222 of data stored on primary storage device 220. Specifically, data may be backed up employing one or more full backups and/or one or more incremental backups. Herein, an incremental backup may also be referred to as a snapshot. Herein, a combination of backup operations that combine to provide a complete, current copy of data on primary storage device 220 is referred to as a complete backup family. Herein, an incremental backup may include storing all changes that have been made to a selected body of data since a preceding backup, whether the preceding backup is a full backup or a prior incremental backup.

A given full backup in combination with one or more incremental backups may form a complete family of backups. In this scenario, the full backup may be referred to as the “parent” backup, and the incremental backups as the children of that parent backup. In this case, full backups preceding the full backup should not be required to provide a complete, current copy of data on the primary storage device 220, but may be useful for other purposes. An example is considered to illustrate this point. Where older, obsolete backups are not needed to provide a complete copy of the desired data, selected ones of the old backups may be discarded to resolve the conflicting priorities of preserving as much data as possible, and limiting the amount of data storage space used. However, selected old backups may be preserved for archival purposes.

An example is considered to illustrate this point. In an exemplary system, full backups are conducted once a week, and incremental backups once per day. Assuming that each of the weeks ends Sunday night, at a specified time on Sunday night, a new full backup may be formed from the previous week's full backup (the current parent backup), and all of the incremental backups made on the days succeeding the parent backup. Also, the incremental backups from the prior incremental backup only show the changes from the last incremental backup, so that a reconstruction of the original data may entail using the prior full backup and all subsequent incremental backup to reconstruct the present data.

Once formed from the preceding backups, the new full backup may be saved to backup storage server 222. Thereafter, the incremental backups from the immediately preceding week may still be preserved for archival purposes. Backup management may entail culling the inventory of backup files such that the granularity with which older backups are preserved decreases with increasing age of the backup file. Thus, in this example, for the preceding week, all the incremental backups may be preserved. A threshold lapse of time may be selected, after which the incremental backups are discarded. For example, for periods more one month before the date of the current full backup, the daily incremental backups may be discarded, while preserving all of the weekly full backups. Continuing with the example, for periods more than six months prior to the date of current full backup, one backup per month could be selected for preservation while weekly full backups between the selected backups could be discarded. This pattern may be extended such that the time gap between successive backups grows larger with increasing age of the backups.

In an exemplary embodiment, a backup server may be located on or off-site, and connected to several client computers or servers over an internal network or remotely via, for example, the Internet. Each computer or server, or subdivision thereof, to be backed up may have its own separate level of granularity for the backup, and for the encryption. Moreover, such levels are individually selectable, based upon user preferences, the data being backed up, or other parameters.

Thus, a first client computer may have its data backed up hourly, while a second client computer may have its data backed up only twice per day, and a third client computer may have half its data backed up daily and the other half backed up hourly. The same backup server may be user configured to perform all of the foregoing, or alternatively, each client computer may include a user interface to allow the user to select the backup interval. The granularity of the encryption is also selectable and may differ among various computers or servers.

A “snapshot manager” algorithm may be operable to save snapshots (backups that supplement the most recent backup) at a data block level of data storage granularity. The data backup intervals (that is, time intervals) at which backups may be conducted may be adjusted based on the computer station, client station, and/or application that is conducting the backup. Thus, different applications may employ the backup interval best suited to its needs. In this manner, applications not requiring frequent backups may be backed up less often, thereby conserving data storage space and saving processing time. Applications benefiting from more frequent backups may be backed up at smaller time intervals and may therefore benefit from the availability of storage space not used by the less frequently backed up applications.

Older snapshots, or incremental backups, may be selectively culled from backup storage device 222. For example, the backup procedure for any given day may include saving one snapshot per minute, but only preserving one snapshot per hour of the previous day's snapshots.

FIG. 10 is a table 1000 showing exemplary data backup intervals for a selection of information categories in accordance with of the present invention. In this example, where the information category is “appointment” the data backup interval for incremental backups for any given day is four hours. For days of the preceding week, including the day preceding the current day, one incremental backup per day may be preserved. For the period prior to the current week, one full backup may be preserved for each week. Thus, in this example, incremental backups saved prior to the most recent week may be discarded. The increments may be measure in terms of transactions occurring, rather than time. Thus, a backup interval may be specified as “Every ten transactions”. Also, the interval may very across units, for example, one per hour, except between 8 PM and 8 AM, when the backup interval should be once every ten transactions.

For the sake of brevity, backup intervals for the remaining exemplary information categories are discussed together. The data backup intervals for incremental backups conducted on a given day for text files and financial information may be one hour and one minute, respectively. The incremental data backups that may be preserved for the preceding day are eight hours apart and 1 hour apart for text files, and financial information, respectively. Incremental backups from the preceding day other than those at stated intervals may be discarded, although their contents may be combined into the preserved incremental backups.
a. In the example, for days in the week preceding the “day prior,” the interval between preserved incremental backups for text files and financial files may be one day and eight hours, respectively. And, for both text files and financial information, the time interval between preserved full backups may be one week. Thus, in this example, incremental backups more than one week old may be discarded for both text files and financial information.

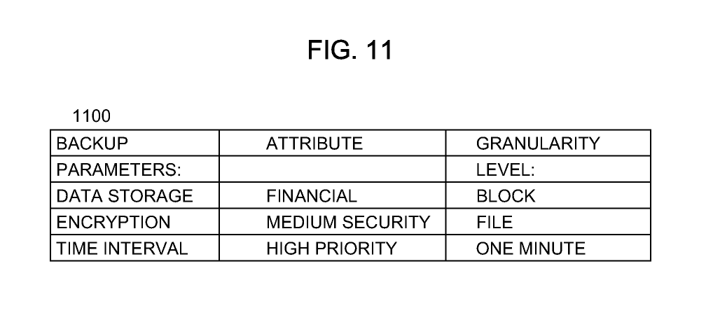

FIG. 11 is a table 1100 showing exemplary values for three backup parameters in accordance with attributes of the data being backed up, in accordance with an exemplary embodiment of the present invention. In this example, table 1100 is directed to the parameters that may be employed when backing up a single file, which may be referred to in this section as the file of table 1100, or simply as “the file.” The first column lists three backup parameters that may be modified in accordance with the present invention. The second column lists attributes of the data being backed up that may be employed to select a setting or value the respective backup parameters. The third column lists the value selected for each of the backup parameters as a function of at least the attribute listed in the second column.

For the purposes of this example, the data element being saved is a file that includes financial information. Given this, the data storage granularity may be determined. The file may be backed up in one or more ways concurrently. A conventional approach is considered first. The file of table 1100 may be backed up by saving an incremental backup, or snapshot, of the block in which the file is stored. Alternatively, a full backup of the block in which the file is stored could be conducted. However, frequent full backups tend to consume undesirably large amounts of storage space. The file of table 1 100 may be saved using a data storage granularity at the “file” level, either in place of, or in addition to, the above-discussed backup at the data block level. In this case, only the file itself would be saved and not a remainder of the data block of which the file forms a part. For this file level backup, a full backup may be preferable. However, either an incremental backup or a full backup of the file of table 1100 may be conducted at the file level. It is further noted that the file level backup and the above-discussed data block level backup may be conducted in an interspersed manner throughout any given day, or other period. Thus, the file of table 1100 may be concurrently backed up at different levels of data storage granularity and/or using different data backup intervals, in backup storage device 222.

Continuing with the example, it remains to determine an encryption granularity level for the file of table 1100 based on a pertinent attribute of the file. In this example, one pertinent attribute may be a security level of the file. In this example, the security level is listed as “medium security.” Accordingly, encryption granularity may be implemented at the “file” level, as indicated by the word “file” in the third column of the “encryption” row of table 1100. Using the file level of encryption granularity, the file may be moved, saved, and/or restored without a need for the key corresponding to the encryption algorithm.

It is noted that the attributes pertinent to selecting a granularity level and the effect of such attributes upon the backup parameters of data storage granularity, encryption granularity level, and the data backup interval may be depend on the client, the application, among other factors. Moreover, the total number of such attributes may be quite large. Accordingly, this document does not present a comprehensive list of possible attributes and the values selected for one or more the backup parameters based on these attributes.

Continuing with the example, it remains to determine the time interval between backups of the file of table 100. For the purpose of this discussion, the time interval is considered to be applicable to the incremental backups, or snapshots, of the data block level backups discussed above, for the file of table 1100. However, in one or more alternative embodiments, time intervals may be determined for full backups and/or for backups occurring at other levels of data granularity.

In this example, the priority level of the file of table 1100 may be considered pertinent to determining the backup time interval. In this case, the priority level may generally correspond to the severity of the consequences of losing the data. Thus, the term “criticality” may also apply to the concept that applies here. Since the financial file of table 1100 may include such information as stock purchases, or other transactions, that may be started and completed within a relatively brief period of time, a “high priority” status is accorded to this file. The data backup interval (for incremental backups) is thus set at low value, in this case, one minute.

An explanation of various priority levels is considered instructive here. When dealing with text files that are gradually added to, and edited, over several days, the loss of one hour's worth of work may present an undesirable, but nevertheless recoverable loss. However, information describing a stock purchase transaction that is completed between 2:27 PM and 2:30 PM on a given day, for example, would be completely lost if a catastrophic data loss were to occur at 2:50 PM, and hourly backups, that are conducted on the hour (that is, at 2:00 PM, 3:00 PM etc.), were in effect. Thus, for stock purchase data and other forms of financial data, smaller time intervals between data backups than those used for text files may be beneficially employed.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. Various aspects of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system comprising a backup server connected to plural computers and a user interface for configuring the granularity of the backup individually for each of said computers so that the backup server stores backups from each of said plural computers customized for each of said computers.

2. The system of claim 1 wherein the granularity of the backup is configurable at each of said computers.

3. The system of claim 1 wherein the granularity of the backup is configurable at the backup server only.

4. The system of claim 1 wherein the granularity may vary within each of said computers and may vary among at least two of the following: file, directory, subdirectory, virtual disk, or data block.

5. The system of claim 1 wherein the granularity is measured in units of time.

6. The system of claim 1 wherein the granularity is measure in units of transactions occurring.

7. The system of claim 5 wherein the granularity of encryption is user configurable.

8. The system of claim 6 wherein the granularity of the encryption is user configurable.

9. A method, comprising:
providing a computer network;
maintaining a backup database for the computer network;
establishing a value of at least one backup parameter for at least one given data element based on at least one attribute of the at least one given data element; and
saving the at least one given data element to the database in accordance with the established value.

10. The method of claim 9 wherein the at least one backup parameter is selected from the group consisting of: a data storage granularity; an encryption granularity level; and a data backup interval.

11. The method of claim 9 wherein the at least one attribute is selected from the group consisting of: an information category; a security level; a priority level; a recency of a last change to the given data element.

12. The method of claim 9 wherein the data element is a file, wherein the at least one backup parameter includes data storage granularity, and wherein the saving step comprises:
saving an incremental backup of the file at a data block level of data storage granularity.

13. The method of claim 9 wherein the data element is a file, wherein the at least one backup parameter includes data storage granularity, and wherein the saving step comprises:
saving a backup of the file at a file level of data storage granularity.

14. The method of claim 12 wherein the saving step further comprises:
saving a full backup of the file at a file level of data storage granularity.

15. The method of claim 9 wherein the attribute of the data element is a high security level, and wherein the establishing step comprises:
encrypting the data element at a data block level.

16. The method of claim 9 wherein the attribute of the data element is a moderate security level, and wherein the establishing step comprises:
encrypting the data element at a file level.

17. The method of claim 9 wherein a first data element has the attribute of being a text file, and wherein the saving step comprises:
conducting incremental backups of the text file using a first data backup interval.

18. The method of claim 17 wherein the incremental backups are conducted at a data block level.

19. The method of claim 17 wherein the saving step further comprises:
conducting full backups of the text file at the file level using a second data backup interval.

20. The method of claim 17 wherein a second data element has the attribute of being a financial file, and wherein the saving step further comprises:
conducting incremental backups of the financial file using a second data backup interval.

21. The method of claim 20 wherein the incremental backups of the financial file are conducted at a data block level.

22. The method of claim 20 wherein the second data backup interval is less than the first data backup interval.

23. A method, comprising:
providing a computer network;
maintaining a backup database for the computer network;
selecting a data storage granularity setting for at least one given data element based on at least one attribute of the at least one data element; and
saving the at least one data element to the database at the selected data storage granularity setting.

24. The method of claim 23 wherein the data storage granularity setting is selected from the group consisting of: a record level; a file level; a directory level; a block level; and a disc level.

25. The method of claim 23 wherein the at least one attribute of the given data element is at least one of: a security level; a priority level; and a recency of a last change to the data element.

26. The method of claim 23 wherein the given data element is one of: a file; an email message; a text file; a directory; a directory tree; a data block; a compact disc; and a hard drive.

27. The method of claim 23 further comprising:
selecting an encryption granularity level for the data element based on the at least one attribute of the data element; and
encrypting the data element in accordance with the selected encryption granularity level.

28. The method of claim 27 wherein the encryption granularity level is selected from the group consisting of: record level; file level; directory level; and block level.

29. The method of claim 23 further comprising:
establishing a data backup interval for the data element based on at least one attribute of the data element; and
conducting backups of the data element in accordance with the established data backup interval.

30. The method of claim 29 wherein step (b) comprises:
conducting a full backup of the given data element using a first data backup interval.

31. The method of claim 30 wherein step (b) further comprises:
conducting at least one incremental backup of the data element using a second data backup interval.

32. A method, comprising:
providing a computer network including at least one backup storage device;
selecting a data element having at least one attribute;
selecting at least one data backup interval for the given data element based the at least one attribute; and
conducting at least one backup of the given data element in accordance with the selected data backup interval.

33. The method of claim 32 wherein the at least one attribute of the data element includes at least one attribute selected from the group consisting of: an information category; a security level; a priority level; a financial value; a cost of loss of the data element.

34. The method of claim 32 wherein the selecting step comprises:
selecting a first data backup interval for conducting full backups; and
selecting a second data backup interval for conducting incremental backups.

35. The method of claim 34 wherein the conducting step further comprises:
conducting at least one full backup in accordance with the first data backup interval; and
conducting at least one incremental backup in accordance with the second data backup interval.
